(19) United States
(12) Patent Application Publication
(10) Pub. No.: US 2025/0189305 A1
(43) Pub. Date: Jun. 12, 2025

(54) Wheel Alignment Equipment User Interface For Selection Of Heavy Duty Vehicle Axle Configurations

(71) Applicant: Hunter Engineering Company, Bridgeton, MO (US)

(72) Inventor: John Boncek, Maryland Heights, MO (US)

(21) Appl. No.: 18/965,541

(22) Filed: Dec. 2, 2024

Related U.S. Application Data
(60) Provisional application No. 63/607,458, filed on Dec. 7, 2023.

(51) Int. Cl. G01B 11/275

(52) U.S. Cl. CPC G01B 11/275

(57) ABSTRACT

A vehicle wheel alignment measurement system adapted for use with a variety of heavy duty vehicles such as truck and trailers, and which provides the user with a graphical interface for selecting and customizing vehicle axle configurations, axle types, and measurement procedures associated with individual axles. Responsive to the user selection and customization, the vehicle wheel alignment measurement system generates a corresponding alignment inspection and/or adjustment procedure for the given vehicle configuration.

### CROSS-REFERENCE TO RELATED APPLICATIONS

The present application is related to, and claims priority from co-pending U.S. Provisional Patent Application Ser. No. 63/607,458 filed on Dec. 7, 2023 which is herein incorporated by reference.

### STATEMENT REGARDING FEDERALLY SPONSORED RESEARCH

Not Applicable.

### BACKGROUND OF THE INVENTION

The present invention is directed towards vehicle wheel alignment measurement systems and in particular, to a system and method for providing an operator with an option to configure a measurement procedure for a heavy duty vehicle such as a truck and/or trailer having multiple axles by identifying a total number of axles including steer axles, fixed axles, and at least one reference axle.

Alignment of the wheels of heavy-duty vehicles, such as trucks and trailers, is difficult due to the wide variety of axle configurations present on these vehicles. Many heavy-duty tractors or trucks include multiple steerable axles, as well as multiple fixed axles. Similar variety exists in heavy duty trailers. When aligning the wheels of a heavy-duty vehicle, and in particular, a heavy-duty vehicle having more than two axles, a variety of reference lines and angles must be measured, determined, and considered to achieve proper wheel alignment for all of the vehicle wheels. One such reference line is the geometric centerline. On a heavy-duty vehicle such as one having more than two axles, the geometric centerline is defined as a line drawn through the midpoint of the front axle and a selected rear reference axle (which is typically a driven axle). Correspondingly, a thrust line for the heavy duty vehicle is defined as the bisector of the total toe angle of the selected reference axle with the thrust angle defined as the angle formed between the geometric centerline and the thrust line. Since vehicles with more than two axles typically have multiple rear axles, there can be multiple thrust lines and thrust angles, depending upon which axle is selected as a reference axle.

An angle formed between two thrust lines of a heavy duty vehicle is referred to as the tandem scrub angle, and is indicative of a misalignment between the selected axles. The effect of this misalignment is that the wheels on the steer axle of the vehicle must be turned to offset the “push” of the selected axles to maintain the vehicle moving in a straight-ahead direction, resulting in tire wear on every tire of the vehicle. This condition can be further amplified due to misalignment in the axles of towed trailers, such as in a tractor-trailer combination, resulting in rapid wear on all of the vehicle tires, increased fuel consumption, and poor vehicle handling. Hence, in order to properly measure the characteristics of individual axles, the operator must initially identify a reference axle against which the relative orientation of the remaining axles on the vehicle will be measured and/or adjusted. Once the reference axle is selected, a sequence in which the individual axles will be measured is established to ensure that individual axle measurements can be properly evaluated relative to the reference axle, thrust angle, and thrust line. A sequence for axle measurements is particularly important for alignment measurement systems which utilize imaging systems and a limited set of wheel-mounted optical targets which must be manually moved from one axle to another to acquire measurements, or in systems with a limited number of wheel-mounted sensor units, so as to ensure that the necessary measurements are acquired in an expected order.

Current alignment measurement systems for heavy duty vehicles require an operator to identify the axle configuration and to select a reference axle for a vehicle undergoing measurement using a fixed menu of predetermined axle configurations, such as shown in FIG. 1. Reliance upon a fixed menu of predetermined axle configurations limits the ability of an operator to utilize the vehicle wheel alignment measurement system to conduct an alignment inspection or adjustment on any heavy duty vehicle having a configuration which is not already identified within the available set of predetermined axle configurations. Accordingly, it would be advantageous to provide a heavy duty vehicle service system with a means by which an operator can conduct an alignment service on a heavy duty vehicle having a unique or non-standard axle configuration which is not included within a predetermined set of available configuration choices.

### BRIEF SUMMARY OF THE INVENTION

Briefly stated, the present disclosure sets forth a vehicle wheel alignment measurement system adapted for use with a variety of heavy duty vehicles such as truck and trailers, and which provides the user with a graphical interface for selecting and customizing vehicle axle configurations, axle types, and measurement procedures associated with individual axles.

In one embodiment of the present disclosure, the vehicle wheel alignment measurement system is configured for use with a heavy duty vehicle by the operator prior to conducting a vehicle wheel alignment inspection or adjustment. Upon selection of a vehicle type, such as a truck or a trailer, a processor of the measurement system is configured to utilize a graphical user interface to present the operator with an interactive means, such as a fillable form, to identify the number of front axles and the number of rear axles present on the vehicle undergoing inspection or adjustment. In response to an operator inputting the number of front and rear axles on the vehicle, the processor is further configured to utilize the graphical user interface to present the operator with a representation of a heavy duty vehicle having the identified axle arrangement. In addition to the vehicle representation, the graphical interface further provides the operator with an input means to identify individual steerable axles, to select a reference axle for the vehicle, and to identify any axles for which the measurement procedures will be modified. Responsive to the operator completing at least an identification of each steerable axle and designating a reference axle, the processor of the vehicle wheel alignment measurement system is configured to generate a wheel alignment measurement process incorporating a set of measurement procedures associated with the selected and identified axles to be carried out by the operator in a sequence guided through the graphical user interface.

In a further embodiment, the processor is configured to use the graphical user interface to provide the operator with dynamic elements such as check boxes or selectable indicia, for the purpose of identifying steerable axles on the heavy duty vehicle representation following designation of a non-steerable reference axle for the vehicle. The dynamic elements are sequentially presented in accordance with a set of logical rules to ensure that the operator cannot designate an axle as steerable if it is not in a position on the vehicle where such an axle could be located. Since the designated reference axle is defined as a non-steerable axle by default, the presentation in the graphical interface prevents the operator from designating the reference axle as a steerable axle. Subject to the initial rule, the operator is permitted to designate a forwardmost axle from the reference axle, and a rearmost axle from the reference axle (if any) as steerable by selecting corresponding dynamic elements on the graphical interface. Continuing the process towards the reference axle from the front and rear of the vehicle, the operator may sequentially designate inwardly-adjacent axles as steerable via selection of dynamic element which are presented on the graphical interface after an outwardly adjacent axle is designated as steerable. The process continues until the operator identifies all of the steerable axles for the vehicle. Once each steerable axle has been designated, the vehicle wheel alignment measurement system generates a measurement or inspection procedure for the vehicle which includes at least a sequence in which individual axles will be measured, and which accounts for each steerable and non-steerable (or fixed) axle.

In another embodiment, the processor is configured to utilize the graphical user interface to provide the operator with a selection element adjacent each axle or sub-set of axles (i.e., multiple front axles) for which a simplified measurement procedure such as toe-only, is permitted during a measurement or inspection of the heavy duty vehicle alignment. The operator may identify each axle, or sub-set of axles, for which the simplified measurement procedure is to be utilized by selecting the corresponding selection element prior to the start of the measurement or inspection process, enabling the vehicle wheel alignment measurement system processor to generate a simplified measurement or inspection procedure for the vehicle which excludes unnecessary measurements or procedures at the selected axles.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a prior art screenshot of a user interface for a heavy-duty vehicle alignment system vehicle axle selection screen;

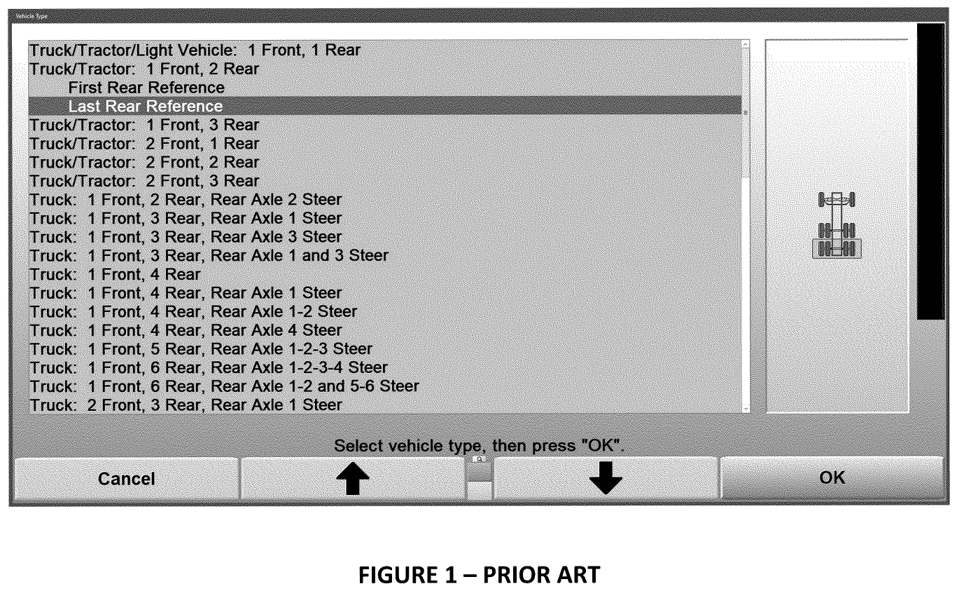

FIG. 2 is a screenshot from a user interface for a heavy-duty vehicle alignment system of the present disclosure, illustrating direct entry of a vehicle axle arrangement;

FIG. 3 is a screenshot from the user interface of FIG. 2, illustrating user identification of steerable axles, a reference axle, and axles for toe-only measurement on a heavy duty truck; and

FIG. 4 is a screenshot from the user interface of FIG. 2, illustrating user identification of steerable axles, a reference axle, and axles for toe-only measurement on a heavy duty trailer.

Corresponding reference numerals indicate corresponding parts throughout the several figures of the drawings. It is to be understood that the drawings are for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

Heavy duty vehicles such as truck and/or trailers have a wide range of axle configurations, and may include multiple steerable axles as well as multiple fixed axles, arranged individually or in sets. In order for a vehicle wheel and/or axle alignment measurement system to accommodate such a variety of heavy duty vehicles there needs to be a means by which the operator can identify the configuration of the vehicle undergoing inspection or measurement.

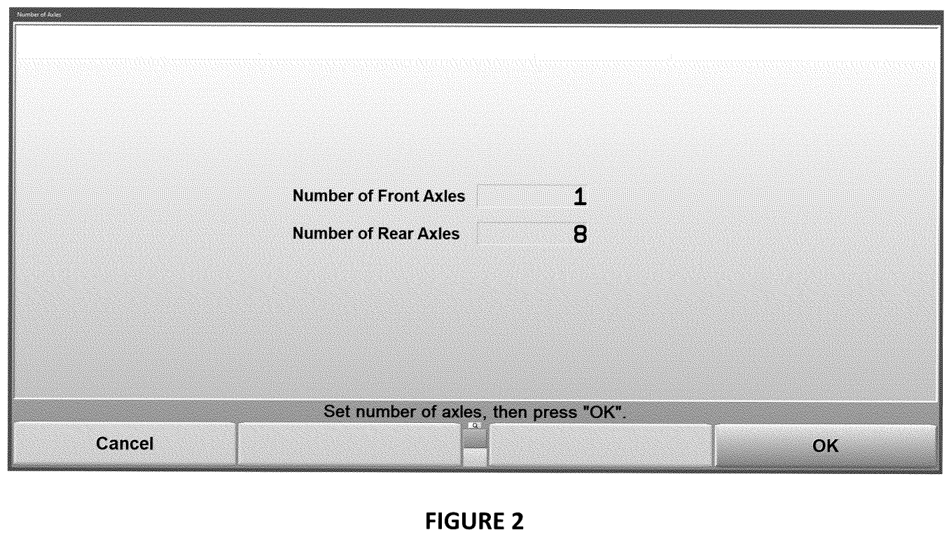

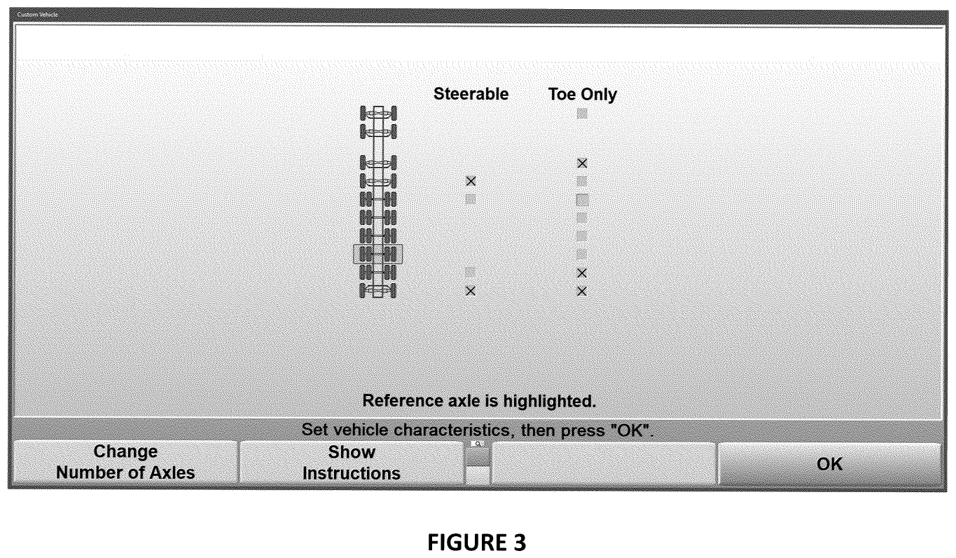

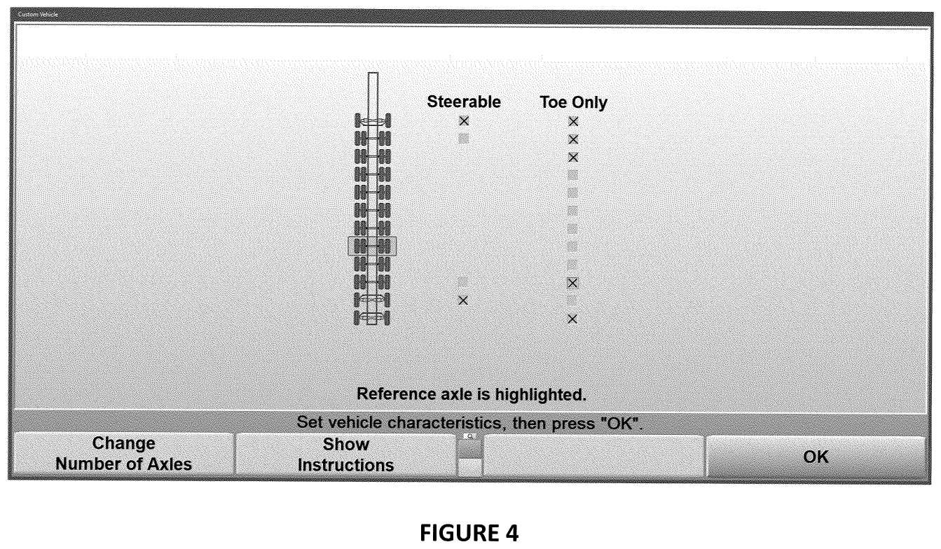

In one embodiment of the present disclosure, a heavy duty vehicle wheel and/or axle alignment measurement system includes a processing system configured with software instructions to provides the operator with an interactive graphical user interface 100, such as shown in FIGS. 2-4, enabling the operator to provide the processing system with configuration data for a vehicle to be inspected, measured, or serviced. The graphical user interface includes interactive elements for selection and customization of vehicle axle configurations, identification of axle types, and for the selection of measurement procedures associated with individual axles. Initially, when an operator begins an inspection or measurement of a heavy duty vehicle, such as a truck or a trailer, the processing system is configured to present the operator with interactive fields 102 in the graphical user interface 100 as shown in FIG. 2, through which the operator may identify the vehicle's axle configuration by providing the number of front axles and the number of rear axles present on the vehicle. When performing an inspection or alignment on a trailer only, a front axle may be designated which corresponds to a king-pin reference tool secured to the trailer. Following operator input of the number of front and rear axles, the processing system is configured to respond to the operator selecting an “OK” or similar continuation-type interactive element 104, such as a button, in the graphical user interface 100 by generating and presenting the operator with a representation 106 of a vehicle having the identified arrangement of front and rear axles, such as shown in FIGS. 3 and 4.

In an initial configuration, each individual axle 108 is represented identically in the graphical user interface, as it is unknown to the processing system which axles are steerable or fixed (non-steerable). Before the operator can designated each axle as a steerable or fixed axle, the processing system requires the operator to designate a reference axle 110 of the vehicle to be used as a measurement base. The operator may designate the reference axle by selecting in the graphical user interface, one of the axle representations. Selection of an axle within the graphical user interface 100 for may be completed by any suitable input, for example by directly “clicking” the designated axle 110 using a pointer, by scrolling a selection box to the designated axle using keyboard commands, or by engaging a dynamic element associated with the designated axle.

Once a reference axle 110 is designated to the processing system through the graphical user interface 100, the operator is selectively presented with a set of dynamic elements 112 such as check boxes, for the purpose of identifying which axles of the heavy duty vehicle representation are steerable axles. A set of rules controls the selective presentation of the dynamic elements adjacent possible steerable axles in a sequential manner to ensure that the operator cannot designate an axle as steerable if it is not in a position on the vehicle where such an axle could be located. The set of rules enforced by the processing system initially requires that the designated reference axle 110, which is commonly a driven rear axle, never be the front or forwardmost axle. Accordingly, the graphical interface 100 is configured to preclude the operator from designating the reference axle 110 as a steerable axle.

Subject to the initial rule, the processing system is configured to permit the operator to designate an axle which is in the forwardmost position from the reference axle, and an axle which is in the rearmost position from the reference axle (if present) as steerable by providing selectable dynamic elements 112 adjacent to the representations of those axles in the graphical interface. In response to the operator designating an axle as a steerable axle by selecting an associated dynamic element, the processing system is configured to repeat the process by providing in the graphical user interface a selectable dynamic element 112 adjacent to a representation of the next adjacent undesignated axle in the longitudinal direction of the reference axle, i.e., the axle in the next longitudinally inward position from either a previously designated forward or rearward steerable axle. For example, if a heavy duty vehicle is identified as having 5 axles, with the forwardmost axle designated as Axle 1, the rearmost axle designated as Axle 5, and Axle 3 selected as the reference axle, the processing system will provide a means for the operator to initially designated both Axle 1 and Axle 5 as steerable axles. If Axle 1 is designated as steerable, the processing system subsequently provides a means for the operator to select Axle 2 as a steerable axle. Correspondingly, if Axle 5 is also designated as steerable, the processing system will provide a means for the operator to designate Axle 4 as a steerable axle. Axle 3, as the reference axle, is automatically excluded as a steerable axle.

The processing system is configured to continue permitting steering axle designations until either all axles other than the reference axle 110 have been designated by the operator as steerable, or the operator terminates the steering axle designation procedure by selection of an “OK” or continue-type button 104 presented in the graphical user interface 100. Once each steerable axle is designated, a measurement or inspection procedure for wheel alignment or axle which is specific for the vehicle is generated by the processing system, accounting for the identified arrangement and total number of steerable and non-steerable (or fixed) axles. When generating a measurement or inspection procedure, the configuration of the processing system requires initial measurements to be obtained from the designated reference axle and at least one additional axle. The additional axles are selected according based on the vehicle axle configuration identified by the operator. For a vehicle having a single front steer axle, additional initial measurements are required from the front axle and the rearmost axle other than the designated reference axle (if any). On a vehicle having two front steer axles (i.e., a twin-steer vehicle), the additional initial measurements are required from both front axles. Trailer-type vehicle which have no steer axle require a single additional measurement from a rearmost axle other than the reference axle. If additional axles are present on the vehicle which are not included in the initial measurement steps, the measurement or inspection procedure generated by the processing system requires individual axles to be measured sequentially, starting with the rearmost unmeasured axle and measuring each longitudinally forward axle along the length of the vehicle until all remaining axles have been measured.

Once the measurement or inspection procedure is generated, the processing system is configured to guide the operator through a sequence of steps necessary to complete the generated measurement or inspection procedure for placing (or moving) optical targets or measurement sensors on the vehicle wheels in a required order or sequence for axle measurement. The sequence of steps begins by directing placement of optical targets or measurement sensors to obtain measurements of the reference axle and a at least one additional axle. Subsequent steps direct the placement or movement of the optical targets or measurement sensors to each remaining axle of the vehicle to acquire associated measurements in the sequence required by the generated measurement or inspection procedure. Operator guidance for the placement or movement of optical targets or measurement sensors is provided to the operator via the graphical interface 100, either automatically when the measurement or inspection procedure is generated, or in response to operator selection of a “show instructions” interactive element of the graphical interface. Following completion of all required measurements, a report displaying the results for each identified axle is generated and communicated to the operator via the graphical user interface, a printout, or an electronic communication.

On some heavy duty vehicles, individual axles may only require or permit limited adjustments to the alignment of the axle or associated wheels. For example, individual drop axles used only to support heavy loads may only require or permit adjustment to individual wheel toe angles, ignoring wheel camber or caster. This provides an opportunity to simplify the inspection and/or measurement process by excluding some measurement steps for those axles. Accordingly, in a further embodiment, the processing system is configured to utilize the graphical user interface to provide the operator with an additional interactive selection elements 114 adjacent each represented axle or a defined group of axles (i.e., multiple front axles) for which a simplified measurement procedure such as toe-only, is needed during a measurement or inspection of the heavy duty vehicle alignment. The operator identifies each individual axle or group of axles for which the simplified measurement procedure is to be utilized by interacting with the corresponding selection elements 114 prior to the start of the measurement or inspection process, enabling the processing system to generate a measurement or inspection procedure for the vehicle which skips or excludes acquisition or calculation of selected measurements for the identified axles.

The present disclosure can be embodied in-part in the form of computer-implemented processes and apparatuses for practicing those processes. The present disclosure can also be embodied in-part in the form of computer program code containing instructions embodied in tangible media, or another computer readable non-transitory storage medium, wherein, when the computer program code is loaded into, and executed by, an electronic device such as a computer, micro-processor or logic circuit, the device becomes an apparatus for practicing the present disclosure.

The present disclosure can also be embodied in-part in the form of computer program code, for example, whether stored in a non-transitory storage medium, loaded into and/or executed by a computer, or transmitted over some transmission medium, wherein, when the computer program code is loaded into and executed by a computer, the computer becomes an apparatus for practicing the present disclosure. When implemented in a general-purpose microprocessor, the computer program code segments configure the microprocessor to create specific logic circuits.

As various changes could be made in the above constructions without departing from the scope of the disclosure, it is intended that all matter contained in the above description or shown in the accompanying drawings shall be interpreted as illustrative and not in a limiting sense.

1. A vehicle wheel alignment measurement system adapted for use with a variety of heavy duty vehicles, comprising
a processing system configured with software instructions to provide a graphical interface having interactive elements for receiving operator input to
a. identify a vehicle axle configuration of a heavy duty vehicle,
b. identify a reference axle on said heavy duty vehicle, and
c. designate steerable and/or non-steerable axles;
wherein said processing system is further configured to utilize said identified vehicle configuration, said identified reference axle, and each designated steerable and/or non-steerable axles to generate an inspection and/or measurement procedure directing a sequence of required axle measurements for said heavy duty vehicle, and to further provide operator instructions on said graphical interface for placement of optical targets or measurement sensors associated with said generated at least one vehicle inspection and/or measurement procedure.

2. The vehicle wheel alignment measurement system of claim 1 wherein said graphical user interface further includes interactive elements adapted to receive operator input identifying any individual axles requiring a reduced set of measurement procedures; and
wherein said processing system is further configured to account for said identified individual axles during generation of said at least one vehicle inspection and/or measurement procedure.

3. The vehicle wheel alignment measurement system of claim 1 wherein said graphical user interface receives operator input identifying a vehicle axle configuration by receiving a numerical identification of a front axle count and a numerical identification of a rear axle count at corresponding interactive elements.

4. The vehicle wheel alignment measurement system of claim 1 wherein said graphical user interface is configured to facilitate identification of said reference axle on the vehicle to said processing system by generating an interactive vehicle representation in response to operator input identifying said vehicle axle configuration, said interactive vehicle representation including a selectable representation of each axle of said vehicle, and wherein selection of one axle representation by said operator identifies said reference axle for said vehicle.

5. The vehicle wheel alignment measurement system of claim 1 wherein said graphical user interface is configured to facilitate designation of each steerable axle on the vehicle by
a. generating a display of a vehicle representation in response to received operator input identifying said vehicle axle configuration and said reference axle, said displayed vehicle representation including a representation of said reference axle, and a representation of each remaining axle of the vehicle located forward of said reference axle and located rearward of said reference axle, wherein each remaining axle is initially identified as a fixed axle;
b. presenting the operator with an axle selection element adjacent to said fixed axle furthest forward on the vehicle from said reference axle, and with an axle selection element adjacent to said fixed axle furthest rearward on the vehicle from said reference axle, if a rearward fixed axle is present;
c. said graphical user interface responding to an operator selection of an axle selection element by designating the associated axle in the vehicle representation as a steerable axle and presenting the operator with an axle selection element adjacent to a next fixed axle located inward towards said reference axle if additional fixed axles are present;
wherein said graphical user interface is further configured to repeat said response to said operator selection of said axle selection elements until either each remaining axle is identified as a steerable axle or the operator indicates identification of steerable axles is complete for the vehicle.

6. The vehicle wheel alignment measurement system of claim 5 wherein each axle selection element is an interactive check-box.

7. The vehicle wheel alignment measurement system of claim 1 further including a set of components for acquiring wheel alignment measurement data from the wheel assemblies on at least two axles of said heavy duty vehicle during said at least one vehicle inspection and/or measurement procedure; and
wherein said processing system is further configured to receive said wheel alignment measurement data from said set of components for comparison to a set of reference specifications for said heavy duty vehicle.

8. The vehicle wheel alignment system of claim 7 wherein said set of components include a set of imaging sensors and a set of optical targets;
wherein each of said optical targets is configured for mounting to a vehicle wheel assembly;
wherein each imaging sensor in said set of imaging sensors has a field of view, and wherein said fields of view are oriented to establish such that each of said optical targets mounted to said vehicle wheel assemblies is visible within at least one field of view; and
wherein said processing system is configured with software instructions to receive images of said optical targets from said plurality of imaging sensors for processing to determine said wheel alignment measurement data.

9. The vehicle wheel alignment measurement system of claim 1 wherein said generated inspection and/or measurement procedure for said heavy duty vehicle includes displaying on said graphical interface, an identification of placement locations and/or a placement sequence for a set of optical targets.

10. A method for generating at least one vehicle inspection and/or measurement procedure for use with a heavy duty vehicle, comprising
receiving through a graphical user interface, operator input to
a. identify a vehicle axle configuration,
b. identify a reference axle on the vehicle, and
c. designate steerable and/or non-steerable axles;
responsive to said received operator input, generating at least one vehicle inspection and/or measurement procedure utilizing said identified vehicle configuration, said identified reference axle, and each designated steerable and/or non-steerable axle, said generated procedure including steps for displaying instructions for sequential placement of a set of optical targets or measurement sensors on each of said vehicle axles to said operator in said graphical user interface, and for acquiring and/or determining a set of measurements for each of said vehicle axles.

11. The method of claim 10 wherein said received operator input further identifies any individual axles of said vehicle requiring a reduced set of measurement procedures; and
wherein said step of generating said procedure is further responsive to said identification of any individual axles to alter a step of acquiring and/or determining a set of measurements by skipping an acquisition and/or determination of at least one measurement for each of said identified individual axles.

12. The method of claim 10 wherein identifying a vehicle axle configuration includes receiving from an operator, numerical indications of a front axle count and a rear axle count.

13. The method of claim 10 wherein said identification of said reference axle on the vehicle includes generating an interactive vehicle representation in said graphical user interface in response to said operator input identifying said vehicle axle configuration, said interactive vehicle representation including a selectable representation of each axle of said vehicle, and
receiving, through said graphical user interface, a selection of one axle representation by said operator identifying said reference axle for said vehicle.

14. The method of claim 10 wherein designation of each steerable axle on the vehicle includes
a. generating a displaying in said graphical user interface of a vehicle representation in response to said received operator input identifying said vehicle axle configuration and said reference axle, said vehicle representation including a representation of said reference axle together with a representation of each remaining axle of the vehicle located forward of said reference axle and located rearward of said reference axle, wherein each remaining axle is initially identified as a fixed axle;
b. presenting an axle selection element in said graphical user interface adjacent to said fixed axle furthest forward on the vehicle from said reference axle, and with an axle selection element adjacent to the fixed axle furthest rearward on the vehicle from the reference axle, if a rearward fixed axle is present;
c. responding to an operator selection of an axle selection element by designating an associated axle in said vehicle representation as a steerable axle and presenting a next axle selection element adjacent to a next fixed axle located inward towards said reference axle if an inward fixed axle is present;
repeating said step of responding to said operator selection of said axle selection elements until either each remaining axle is identified as a steerable axle or an indication that said selection is complete for the vehicle is received.

15. The method of claim 10 wherein said generated at least one vehicle inspection and/or measurement procedure requires obtaining an initial set of measurements from said identified reference axle and at least one additional axle.

16. The method of claim 15 wherein, for a vehicle having a single front steer axle, said at least one additional axle includes a front axle and a rearmost axle other than said identified reference axle, if said rearmost axle is present.

17. The method of claim 15 wherein, for a vehicle having twin front steer axles, said at least one additional axle includes each front steer axle.

18. The method of claim 15 wherein, for a vehicle having no steer axle, said at least on additional axle includes a rearmost axle other than said identified reference axle.

19. The method of claim 15 wherein, for vehicles having remaining unmeasured axles after said initial set of measurement are obtained, said measurement or inspection procedure requires individual remaining axles to be measured sequentially, starting with a rearmost unmeasured axle and moving forward along a length of said vehicle until measurements are obtained from all remaining unmeasured axles.

20. A method for generating a customized wheel and/or axle alignment measurement procedure for a heavy duty vehicle, comprising
identifying an axle configuration for said heavy duty vehicle, said identification of axle configuration including a count of axles designated as front axles, and a count of axles designated as rear axles;
designating a reference axle for said heavy duty vehicle;
identifying each steerable or each non-steerable axle on said heavy duty vehicle;
generating a wheel and/or axle alignment measurement procedure responsive to said identified axle configuration, said designated reference axle, and each identified steerable or non-steerable axle, said generated procedure including a sequence for placement of a set of optical targets or measurement sensors on each axle of said heavy duty vehicle and a sequence for acquisition and/or determination of a set of measurements for each of said axles.

21. The method of claim 20 further including displaying, in a graphical user interface, a representation of said sequence for placement of said set of optical target or measurement sensors.
